(19) United States
(12) Patent Application Publication
(10) Pub. No.: US 2012/0038240 A1
(43) Pub. Date: Feb. 16, 2012

(54) FUEL PUMP AND METHOD OF MAKING THE SAME

(75) Inventors: Rihito ASAI, Kariya-city (JP); Kiyotoshi Oi, Anjo-city (JP); Motoya Itoh, Hekinan-city (JP); Hideki Koyama, Okazaki-city (JP); Isao Kawasaki, Nishio-city (JP); Masaru Gaman, Okazaki-city (JP)

(73) Assignee: DENSO CORPORATION, Kariya-city (JP)

(21) Appl. No.: 13/205,894

(22) Filed: Aug. 9, 2011

(30) Foreign Application Priority Data
Aug. 16, 2010 (JP) 2010-181758
Mar. 30, 2011 (JP) 2011-75098

(51) Int. Cl. H01R 39/36; H01S 4/00

(52) U.S. Cl. 310/249; 29/592.1

(57) ABSTRACT

A fuel pump includes a pump part, a motor part, two brushes, two pigtails, and an urging member. Each pigtail is made of a linear conductive member and includes one end portion electrically and mechanically connected to its corresponding brush. The urging member includes one end engaged with a motor casing, and the other end pressing and urging each brush against a commutator from its other axial end face. A distance between an inclined surface of the brush and a sliding surface of the commutator in an axial direction of the brush becomes longer toward a rear side of the brush in a rotation direction of the commutator. A side surface of each brush and an inner wall of the motor casing, which defines two brush accommodating chambers, define a clearance therebetween. Each pigtail includes an extension portion extending from its one end portion toward the rear side in the rotation direction of the commutator.

### CROSS REFERENCE TO RELATED APPLICATION

This application is based on and incorporates herein by reference Japanese Patent Application No. 2010-181758 filed on Aug. 16, 2010, and Japanese Patent Application No. 2011-75098 filed on Mar. 30, 2011.

### BACKGROUND OF THE INVENTION

1. Field of the Invention

The present invention relates to a fuel pump that drives its pump part by driving force of its motor part to pressure-feed suctioned fuel.

2. Description of Related Art

A fuel pump that supplies fuel in a fuel tank to an internal combustion engine is widely known. The fuel pump pressurizes the fuel which is suctioned from the fuel tank at its pump part, and supplies the fuel to the engine. A motor part of the fuel pump includes a commutator made up of segments, and carries out a supply or cuffing off of an electric current to the commutator as a result of a sliding contact of a brush, which is energized, with the commutator. In JP-A-2007-023784, an urging member presses a brush on a commutator with the brush leaned toward the rear in a rotation direction of the commutator, so that generation of electric discharge between the commutator and the brush is curbed, and abnormal wear of the commutator and the brush are reduced.

In the fuel pump described in JP-A-2007-023784, an electrical connection to the brush is ensured by means of a pigtail which is obtained by bundling together linear conductive members. If the pigtail is connected to the brush from the front in the rotation direction of the commutator, the brush is also urged toward the front in the rotation direction of the commutator by resilient force of the pigtail. Consequently, when the contact between the commutator rotating and the brush at the front in the rotation direction of the commutator is released, the electric discharge by surge voltage between the commutator and the brush is easily generated. When an electrical current is discharged between the commutator and the brush, the commutator and the brush readily cause unusual wear.

### SUMMARY OF THE INVENTION

The present invention addresses at least one of the above disadvantages.

According to the present invention, there is provided a fuel pump comprising a pump part, a motor part, two brushes, two pigtails, and an urging member. The pump part includes an impeller and is configured to suction and pressurize fuel. The motor part includes a rotor, a commutator, and a motor casing. The rotor is coupled with a rotating shaft of the impeller to be capable of rotating the impeller. The commutator is rotated together with the rotor to rectify an electric current supplied to the rotor. The motor casing accommodates the rotor and the commutator. Each of the two brushes includes a side surface and one axial end face that slides on the commutator to be electrically connectable to the commutator, and the two brushes are accommodated in the motor casing movably in an axial direction thereof. Each of the two pigtails is made of a linear conductive member and includes one end portion that is electrically and mechanically connected to a corresponding one of the two brushes. The urging member includes one end which is engaged with the motor casing, and the other end which is configured to press and urge each of the two brushes against the commutator from the other axial end face of the each of the two brushes. The other axial end face of each of the two brushes, with which the other end of the urging member is in contact, includes an inclined surface. A distance between the inclined surface and a sliding surface of the commutator, on which the one axial end face of each of the two brushes slides, in an axial direction of the each of the two brushes becomes longer toward a rear side of the each of the two brushes in a rotation direction of the commutator. The motor casing includes two brush accommodating chambers, each of which accommodates a corresponding one of the two brushes. The side surface and an inner wall of the motor casing, which defines each of the two brush accommodating chambers, define a clearance therebetween. Each of the two pigtails includes art extension portion extending from the one end portion thereof toward the rear side in the rotation direction of the commutator.

According to the present invention, there is also provided a method for making the fuel pump. According to the method, a first connecting process is performed. In performing the first connecting process, the one end portion of each of the two pigtails is connected to a corresponding one of the two brushes. Furthermore, a second connecting process is performed. In performing the second connecting process, the other end portion of each of the two pigtails is electrically and mechanically connected to a corresponding one of two brush terminals configured to supply electric power to the each of the two pigtails. Then, a flexural formation process is performed after the first and second connecting processes. In performing the flexural formation process, each of the two brushes and a corresponding one of the two brush terminals are brought close to each other, with each of the two pigtails connected to a corresponding one of the two brushes and to a corresponding one of the two brush terminals, so as to shorten a distance between the one end portion and the other end portion of the each of the two pigtails and thereby to provide a flexure for the each of the two pigtails. Subsequently, a first extension portion formation process is performed after the flexural formation process. In performing the first extension portion formation process, the extension portion is provided for each of the two pigtails. The extension portion extends toward the rear side in the rotation direction of the commutator.

According to the present invention, there is further provided a method for making the fuel pump. According to the method, an attachment process is performed. In performing the attachment process, the two brushes and two brush terminals are attached to the motor casing, each of the two brush terminals being configured to supply electric power to a corresponding one of the two pigtails. Furthermore, a third connecting process is performed. In performing the third connecting process, the one end portion of each of the two pigtails is connected to a corresponding one of the two brushes. In addition, a fourth connecting process is performed. In performing the fourth connecting process, the other end portion of each of the two pigtails is connected to a corresponding one of the two brush terminals. Then, a second extension portion formation process is performed after the attachment process and the third and fourth connecting processes. In performing the second extension portion formation process, the extension portion is provided for each of the two pigtails with the two brushes and the two brush terminals attached to the motor casing. The extension portion extends toward the rear side in the rotation direction of the commutator.

### BRIEF DESCRIPTION OF THE DRAWINGS

The invention, together with additional objectives, features and advantages thereof, will be best understood from the following description, the appended claims and the accompanying drawings in which:

FIG. 1 is a sectional view generally illustrating a fuel pump in accordance with a first embodiment of the invention;

FIG. 2 is a sectional view taken along a line II-II in FIG. 1 and is an enlarged view illustrating vicinity of a brush;

FIG. 3 is a diagram roughly illustrating configuration of the vicinity of the brush of the fuel pump in accordance with the first embodiment with the vicinity viewed from a direction of an arrow III in FIG. 2;

FIG. 4 is a schematic view illustrating electric configuration of a coil in the fuel pump in accordance with the first embodiment;

FIG. 5A is a bottom view illustrating a motor casing in the fuel pump in accordance with the first embodiment;

FIG. 5B is a sectional view taken along a line VB-VB in FIG. 5A;

FIG. 5C is a sectional view taken along a line VC-VC in FIG. 5A;

FIG. 6 is a schematic view illustrating a method of making the fuel pump in accordance with the first embodiment;

FIG. 7A is a schematic view illustrating a process following FIG. 6 in the method of making the fuel pump in accordance with the first embodiment;

FIG. 7B is a sectional view taken along a line VIIB-VIIB in FIG. 7A;

FIG. 8A is a schematic view illustrating a process following FIGS. 7A and 7B in the method of making the fuel pump in accordance with the first embodiment;

FIG. 8B is a sectional view taken along a line VIIIB-VIIIB in FIG. 8A;

FIG. 9 is a schematic view illustrating a relationship between an electric current flowing between the brush and a commutator in the fuel pump and surge voltage in accordance with the first embodiment;

FIG. 10 is a schematic view illustrating a positional relationship between a pigtail and the brush in the fuel pump in accordance with the first embodiment;

FIG. 11 is an enlarged view showing XI in FIG. 5A and illustrating a forming angle of the pigtail in accordance with the first embodiment;

FIG. 12 is a schematic view illustrating a relationship of the forming angle of the pigtail, and the amount of sparks generated between the commutator and the brush, in the fuel pump in accordance with the first embodiment;

FIG. 13A is a schematic view illustrating a method of making a fuel pump in accordance with a second embodiment of the invention; and

FIG. 13B is a schematic view illustrating the method of making the fuel pump in accordance with the second embodiment.

### DETAILED DESCRIPTION OF THE INVENTION

Embodiments of the invention will be described below in reference to the accompanying drawings.

### First Embodiment

A fuel pump 10 in accordance with a first embodiment of the invention is an in-tank pump that is disposed in a fuel tank of a vehicle, for example. The fuel pump 10 supplies fuel inside the fuel tank to an engine. The fuel pump 10 includes a pump part 12 that pressurizes the suctioned fuel, and a motor part 14 that drives the pump part 12. The motor part 14 is a direct-current motor with a brush. The fuel pump 10 includes a housing 16 having a generally cylindrical shape. A permanent magnet 18 is disposed annularly in the circumferential direction on an inner wall surface of the housing 16. A rotor 20 is disposed radially inward of the permanent magnet 18 concentrically with the annular permanent magnet 18.

The pump part 12 includes a casing main body 31, a casing cover 32, and an impeller 33 which is a rotation member. The casing main body 31 and the casing cover 32 define a generally C-shaped pump passage 34. The impeller 33 is accommodated rotatably between the casing main body 31 and the casing cover 32. The casing main body 31 and the casing cover 32 are formed by, for example, die casting of aluminum. The casing main body 31 is fixed in one end side of the housing 16 in an axial direction thereof by press fitting. A bearing 35 that rotatably supports a shaft 21, which is connected to the impeller 33, is disposed at a central part of the casing main body 31.

The casing cover 32 is fixed to one end portion of the housing 16 by calking, for example, with the casing main body 31 covered in the cover 32. A thrust bearing 36 that limits axial displacement of the shaft 21 is fixed at a central part of the casing cover 32. The casing cover 32 has a fuel inlet 38.

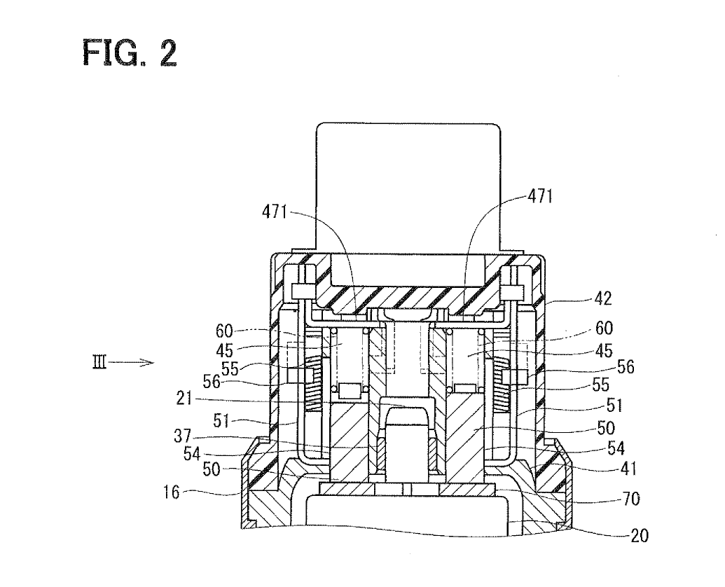

A motor casing 41 and a fuel discharge cover 42 are disposed at the other end portion of the housing 16, i.e., on the opposite side of the housing 16 from the casing main body 31 and the casing cover 32. The motor casing 41 is located between the fuel discharge cover 42 and the housing 16. The fuel discharge cover 42 is fixed to the housing 16 by calking. The motor casing 41 includes a connecting passage 44 that connects a pump chamber 22 and a fuel passage 43 of the fuel discharge cover 42. The motor casing 41 defines a brush accommodating chamber 45 which accommodates a brush 50 such that the brush 50 can be reciprocated in its axial direction, as illustrated in FIG. 2. The motor casing 41 is a housing that defines the brush accommodating chamber 45, in which the brush 50 is accommodated. The motor casing 41 accommodates the brush 50, and a compression spring 60 serving as an urging member in its brush accommodating chamber 45.

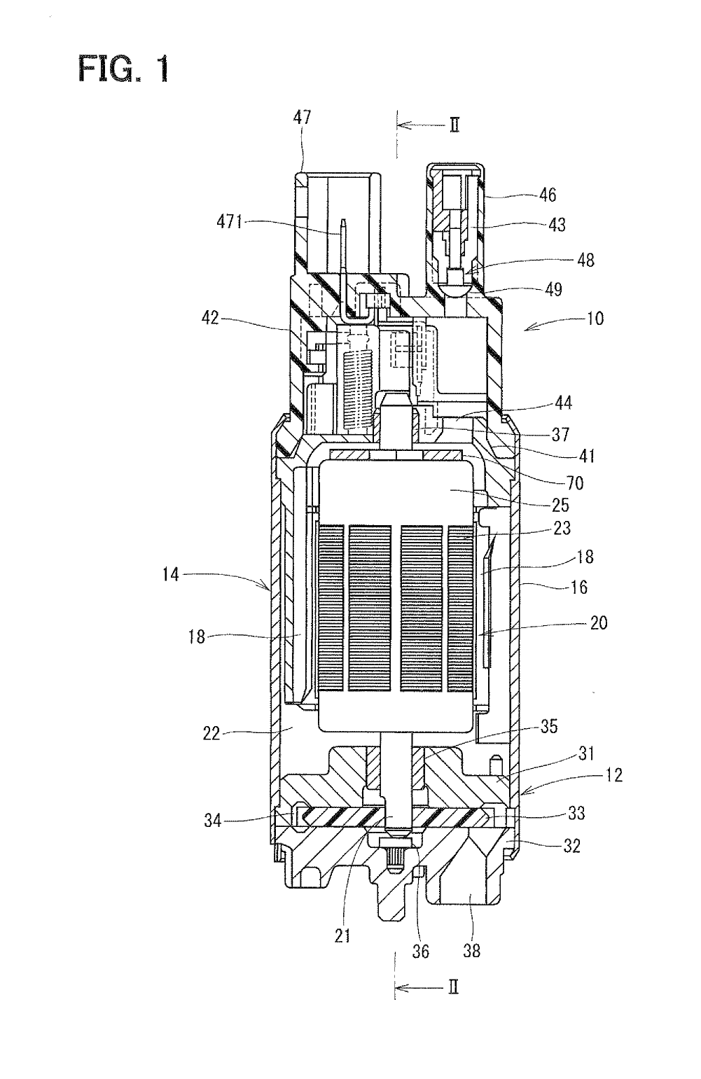

The fuel discharge cover 42 includes a fuel discharge part 46 and an electric connector part 47 radially outward of the shaft 21, as illustrated in FIG. 1. The fuel discharge part 46 includes the fuel passage 43 and a pressure regulating valve 48. The fuel passage 43 is opened or closed by a valve member 49 of the pressure regulating valve 48. When the pressure of fuel inside the fuel pump 10 becomes larger than a predetermined value, the valve member 49 opens the fuel passage 43. The fuel discharge cover 42 may correspond to a “motor casing”.

The electric connector part 47, which is connected to the outside of the fuel pump 10, includes a terminal 471. The terminal 471 is electrically connected to a pigtail 51 through a choking coil 55 and a brush terminal 56, as illustrated in FIG. 2. The pigtail 51 is electrically connected to a side surface 54 of the surfaces constituting the brush 50 that is located on the opposite side from a rotation center of a commutator 70.

The rotor 20 is accommodated rotatably in the housing 16, as illustrated in FIG. 1. One end portion of the shaft 21 of the rotor 20 is rotatably supported by the bearing 35 in its radial direction; and the other end portion of the shaft 21 of the rotor 20 is rotatably supported by the bearing 37 in the radial direction. A winding wire that constitutes a coil 23 is wound around an outer peripheral surface of the core 25, which is fixed to the shaft 21. As illustrated in FIG. 2, the commutator 70 is formed in the shape of a circular disk, and disposed above the rotor 20. More specifically, the commutator 70 is located at an end portion of the rotor 20 on its opposite side from the pump part 12.

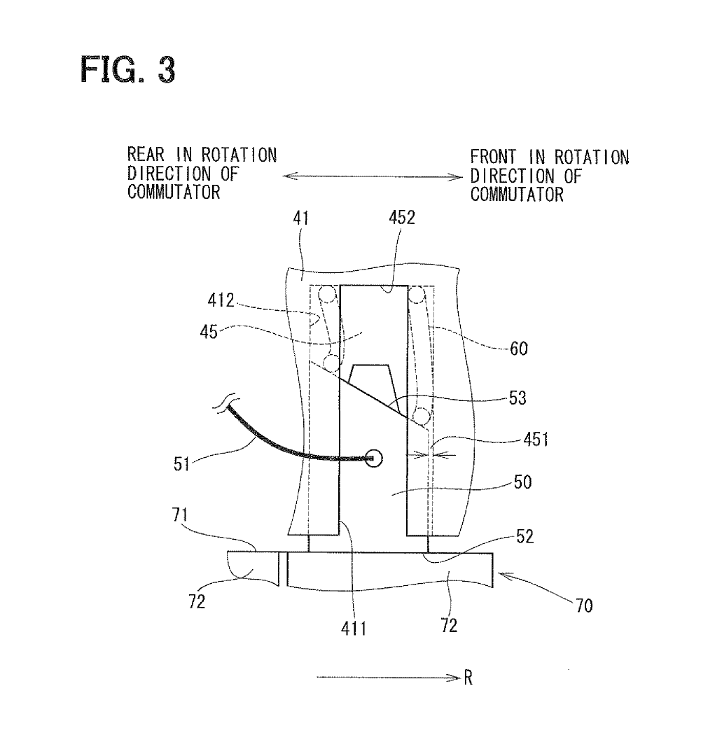

Next, the brush 50 will be described in detail. The brush 50 is accommodated in the brush accommodating chamber 45 of the motor casing 41 as illustrated in FIG. 3. The brush 50 is guided by the brush accommodating chamber 45 defined by an inner wall 412 of the motor casing 41, to reciprocate in its axial direction. The brush accommodating chamber 45 includes an opening 411 on its part in the circumferential direction, as illustrated in FIG. 3. The pigtail 51, which is connected to the brush 50, is taken out from the opening 411 of the brush accommodating chamber 45. Accordingly, in the case of reciprocation movement of the brush 50 in its axial direction along the inner wall 412 of the motor casing 41, the pigtail 51 connected to the brush 50 moves in the axial direction, following the brush 50.

The brush accommodating chamber 45 of the motor casing 41 is formed to be slightly larger on its interior side than the brush 50. Accordingly, a slight clearance 451 is formed between the brush 50 and the inner wall 412 of the motor casing 41. In FIG. 3, the clearance 451 is overdrawn in order to describe the clearance 451 between the brush 50 and the motor casing 41 in a straightforward manner.

The brush 50 is in contact with the compression spring 60 on its one inclined surface 53 in the axial direction. The other end portion of the compression spring 60 is in contact with an upper part 452 of the brush accommodating chamber 45. The compression spring 60 has extending force. Consequently, an end face 52 of the brush 50 is pressed on a sliding surface 71 of the commutator 70.

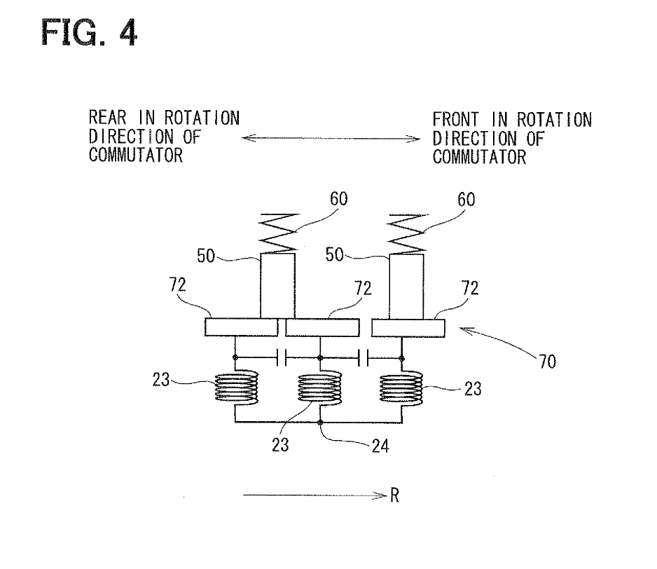

The commutator 70 is constituted of segments 72, which are divided in its circumferential direction. The segments 72 are connected respectively to the winding wires of the coils 23, as illustrated in FIG. 4. As a result of a repeated contact between the brush 50 and each segment 72 of the commutator 70, an electric current supplied to the coil 23 is rectified. The commutator 70 rotates together with the rotor 20 (see FIG. 2) in a direction of an arrow R indicated in FIGS. 3 and 4. Therefore, in FIGS. 3 and 4, the front in a rotation direction of the commutator 70 is located on the right-hand side; and the rear in the rotation direction of the commutator 70 is located on the left-hand side.

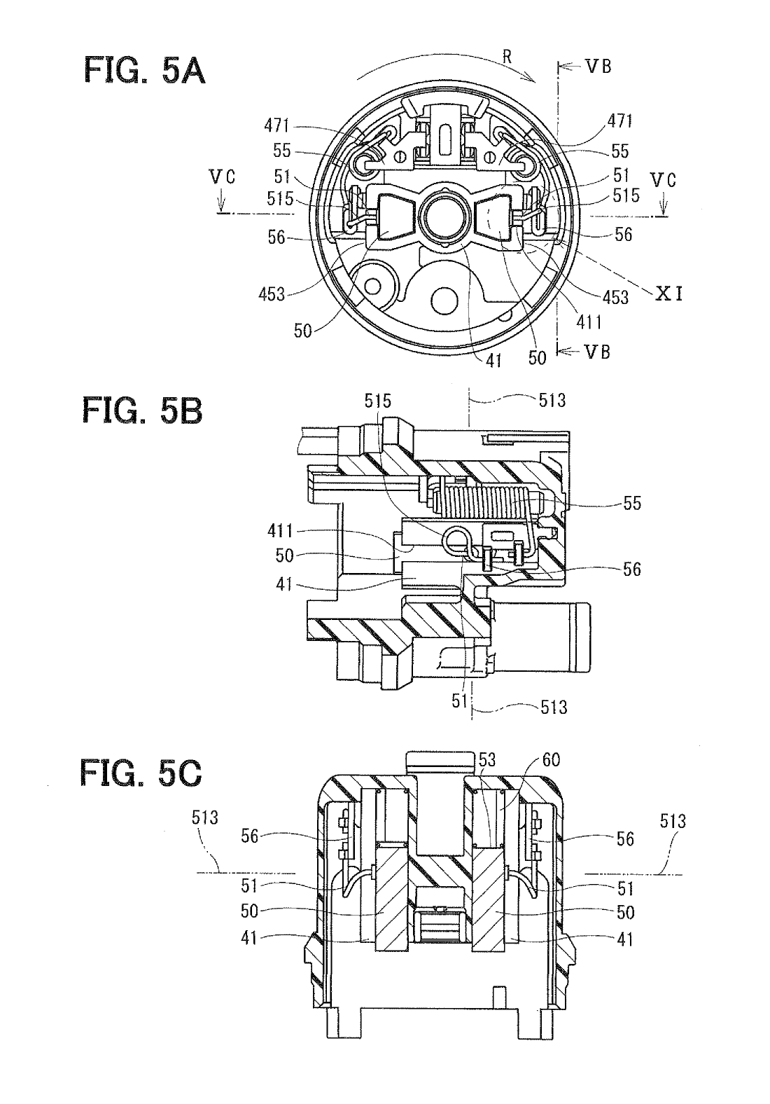

In the first embodiment, as illustrated in FIGS. 5A to 5C, one end portion of the pigtail 51 is connected to the brush 50, and the other end portion of the pigtail 51 is connected to the brush terminal 56. The rotation direction of the commutator 70 is the clockwise direction, as illustrated in FIG. 5A. The pigtail 51, which is connected mechanically and electrically to the side surface 54 of the brush 50, is pulled out in the opposite direction from the rotation center of the commutator 70 through the opening 411 of the motor casing 41. The pigtail 51, which is drawn out up to an outer wall 453 of the brush accommodating chamber 45, includes an extension portion 515 extending on its rear side in the rotation direction of the commutator 70 toward a contact surface of the commutator 70 and the brush 50, as illustrated in FIG. 58. After that, the pigtail 51 changes its extending direction at a generally intermediate portion of the pigtail 51, and extends to its front in the rotation direction of the commutator 70 toward a direction of the inclined surface 53. Lastly, the other end of the pigtail 51 is connected to the brush terminal 56 provided for the fuel discharge cover 42 on a generally lateral side of the brush 50.

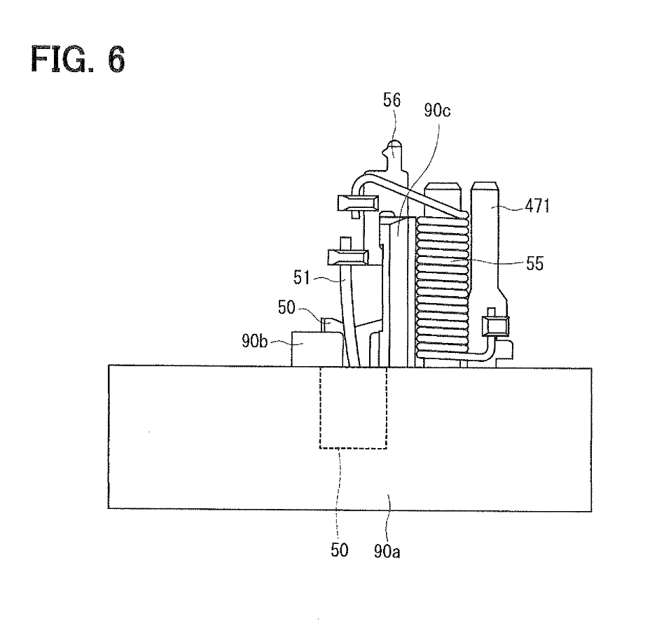

A production method for the fuel pump 10 will be described. A formation process for the extension portion 515 of the pigtail 51 in the fuel pump 10 will be explained in reference to FIGS. 6 to 8B. The process for forming the extension portion 515 includes mainly the following processes. Firstly, as illustrated in FIG. 6, the terminal 471, the choking coil 55, the brush terminal 56, the pigtail 51, and the brush 50 are attached to component attachment pallets 90a, 90b, 90c. Meanwhile, the brush 50 is accommodated in an accommodating hole that is formed in the attachment pallet 90a along the attachment pallet 90b. One end portion of the pigtail 51 is connected to the brush 50. The other end portion of the pigtail 51 is connected to the brush terminal 56. The pigtail 51 has a generally linear shape, since the brush 50 and the brush terminal 56, which are connected to the pigtail 51, are attached to the component attachment pallets 90a, 90b, 90c separately from each other.

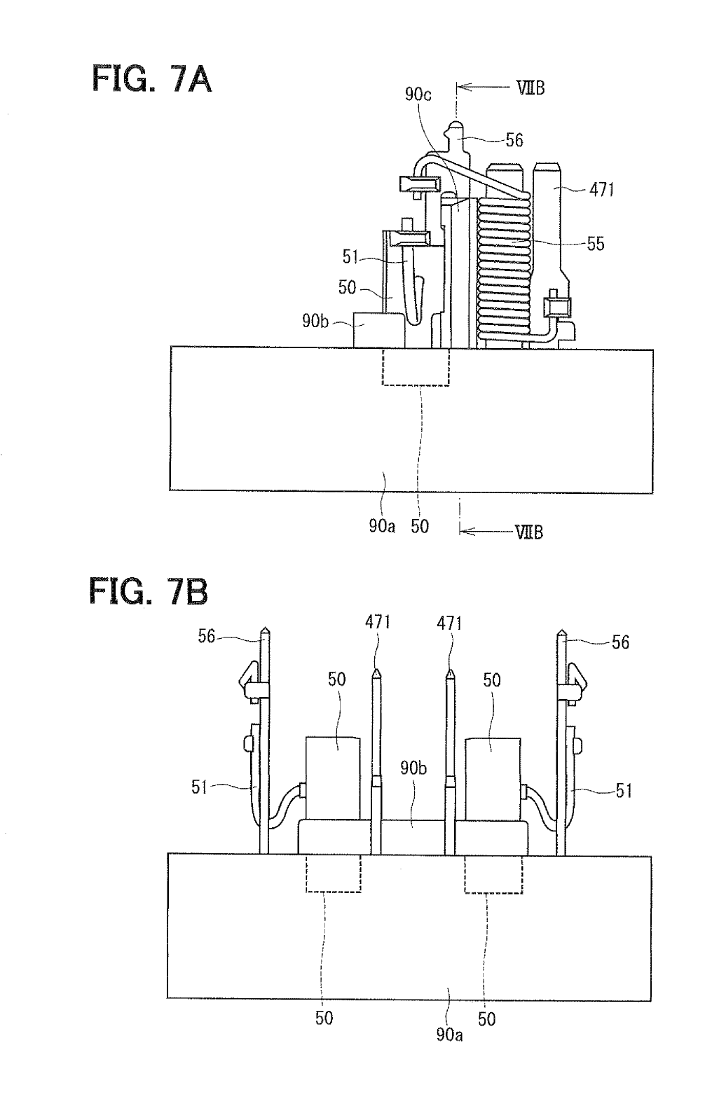

Next, in a flexural formation process, the brush 50 accommodated in the attachment pallet 90a is displaced toward the brush terminal 56, as illustrated in FIG. 7A. More specifically, a distance between one end portion of the pigtail 51, which is connected to the brush 50, and the other end portion of the pigtail 51, which is connected to the brush terminal 56, is shortened. Accordingly, the pigtail 51 has a flexure toward the reader through a plane of paper in FIG. 7A.

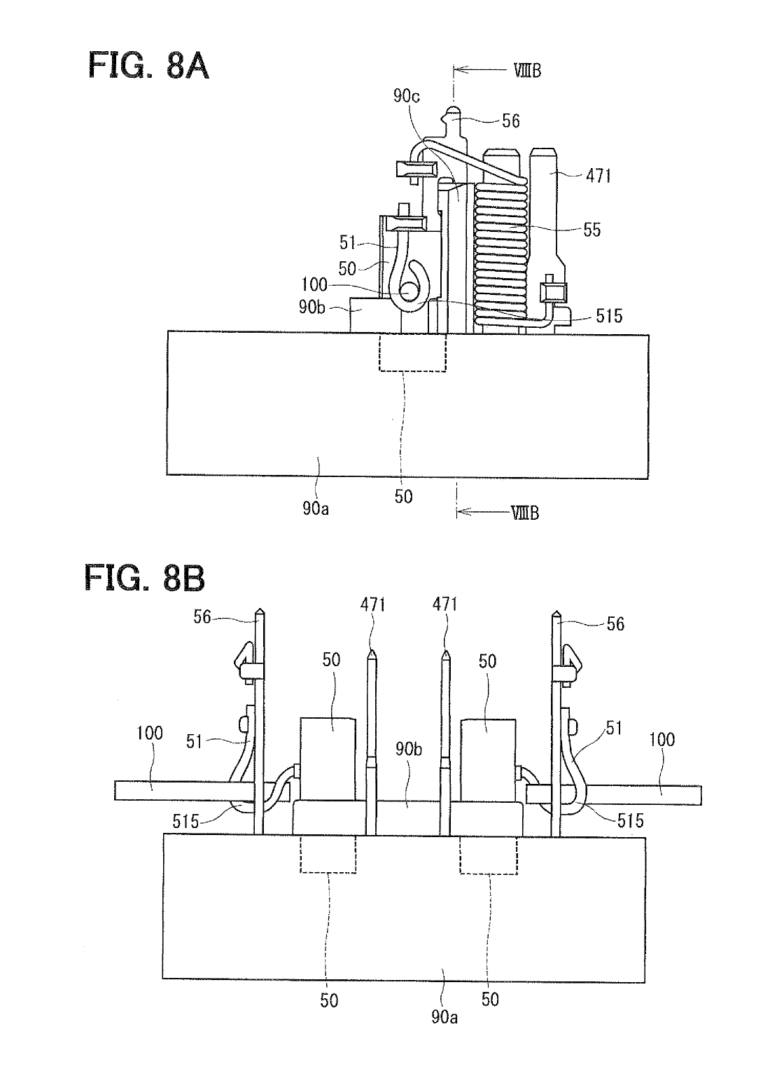

After the above-described flexural formation process, as illustrated in FIGS. 8A and 8B, the extension portion 515 is formed by means of an extension portion formation jig 100 such that a flexure shape of the pigtail 51 is parallel to the side surface 54 of the brush 50. Because the two pigtails 51 respectively have the extension portions 515 extending toward their rear sides in the rotation direction of the commutator 70, the pigtail 51 on the left-hand side in FIG. 8B includes the extension portion 515 in a direction away from the coil 55. On the other hand, the pigtail 51 on the right-hand side in FIG. 8B includes the extension portion 515 in a direction toward the coil 55.

Operation of the fuel pump 10 will be described. The electric current, which is supplied to the terminal 471 from a power source (not shown), is fed to the commutator 70 through the brush terminal 56, the pigtail 51, and the brush 50. The electric current, which is fed into the commutator 70, is supplied to the coil 23 of the rotor 20. When the rotor 20 is rotated by the electric current supplied to the coil 23, the impeller 33 rotates together with the rotor 20 and the shaft 21. When the impeller 33 rotates, fuel is suctioned from the fuel inlet 38 into the pump passage 34. The fuel drawn into the pump passage 34 is discharged from the pump passage 34 into the pump chamber 22 as a result of the application of kinetic energy thereto by each blade groove of the impeller 33. The fuel discharged into the pump room 22 is supplied to the outside of the fuel pump 10 through a surrounding area of the rotor 20 and the fuel passage 43.

The brush 50, which supplies an electric current to the commutator 70, is brought into contact with the commutator 70, with the brush 50 inclined toward its rear side in the rotation direction of the commutator 70, as illustrated in FIG. 10, by urging force of the compression spring 60, which is in contact with the inclined surface 53. The pigtail 51, which is connected to the brush 50 from the rear side in the rotation direction of the commutator 70, pulls the brush 50 to the rear side in the rotation direction of the commutator 70.

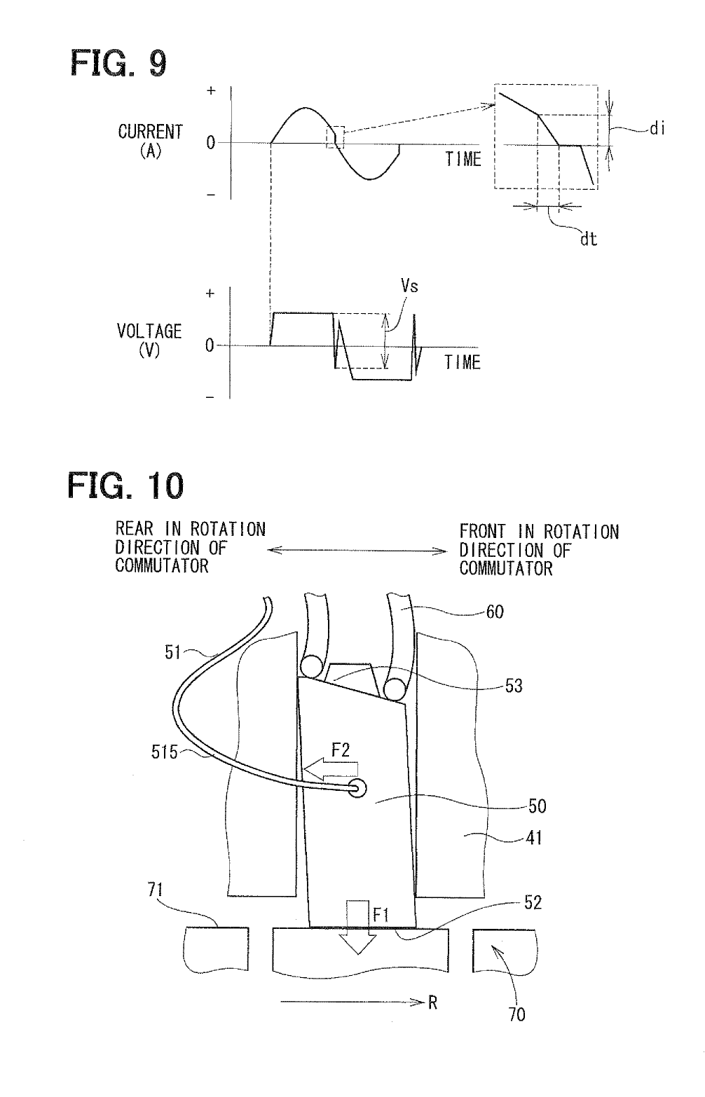

In the case of the rotor 20 having the coil 23, to which a “star connection” is applied, as illustrated in FIG. 4, one end portion of each coil 23 is connected to a connection part 24; and the other end portion of each coil 23 is connected to its corresponding segment 72 of the commutator 70. For this reason, when the contact between the brush 50 and each segment 72 of the commutator 70 is released, a residual current “di” changes rapidly during a short time “dt”, as illustrated in FIG. 9. As a result, electric energy stored in the coil 23 is released between the brush 50 and the commutator 70; and a surge voltage Vs is generated between the brush 50 and the commutator 70. Accordingly, a spark discharge is created between the brush 50 and the commutator 70. The spark discharge between the brush 50 and the commutator 70 causes electric wear of the brush 50 and the commutator 70.

Effects of the fuel pump 10 of the first embodiment of the invention will be described. As illustrated in FIG. 10, pressing force F1 by the compression spring 60 and tension F2 by the pigtail 51 are applied to the brush 50. More specifically, the pressing force F1 is force whereby the sliding surface 52 of the brush 50 is pressed against the commutator 70 due to the compression spring 60 acting on the inclined surface 53 of the brush 50. On the other hand, the tension F2 is force whereby the pigtail 51, which is connected to the brush 50 from its rear side in the rotation direction of the commutator 70, pulls the brush 50 to its rear side in the rotation direction of the commutator 70.

The brush 50 slides on the commutator 70 with its inclined surface 53 inclined to the rear side in the rotation direction of the commutator 70. Accordingly, the pressing force of the brush 50 on the commutator 70 becomes larger further in a direction in which the brush 50 inclines, i.e., toward the rear in the rotation direction of the commutator 70. The pressing force of the brush 50 against the commutator 70 becomes smaller further on the front side in the rotation direction of the commutator 70.

Ease of flowing of the electric current between the commutator 70 and the brush 50 is determined by a contact state between a rectification surface 71 of the commutator 70 and the sliding surface 52 of the brush 50. When there are fewer foreign substances and the rectification surface 71 and the sliding surface 52 are more closely-attached to each other, contact resistance between the commutator 70 and the brush 50 becomes smaller, and the electric current thereby more easily flows. Thus, the contact resistance becomes smaller on the rear side in the rotation direction of the commutator 70. On the front side in the rotation direction of the commutator 70, on the other hand, the electric current does not easily flow between the commutator 70 and the brush 50 as compared with the rear side in the rotation direction of the commutator 70, and an occurrence of electric discharge is accordingly limited. As a consequence, abnormal wear of the commutator 70 and the brush 50 due to the electric discharge caused when the contact of the commutator 70 and the brush 50 is released can be reduced.

In the conventional technology, the pigtail, which is connected from the front side in the rotation direction of the commutator, urges the brush to the front in the rotation direction of the commutator. Accordingly, the pressing force is applied to the brush on the rear side in the rotation direction of the commutator by the compression spring, whereas tension is applied to the brush on the front side in the rotation direction of the commutator. Hence, the direction of the pressing force of the brush against the commutator is not concentrated on the rear side in the rotation direction of the commutator, so that the magnitude of the pressing force is not stable.

In comparison to this conventional technology, in the fuel pump 10 of the first embodiment of the invention, the pigtail 51 is formed to urge the brush 50 on the rear side in the rotation direction of the commutator 70. In consequence, the brush 50 becomes stable with the load applied to the rear side of the brush 50 in the rotation direction of the commutator 70, and the direction of pressing of the brush 50 against the commutator 70 is also stabilized. As a result, when the contact between the rotating commutator 70 and the brush 50 is released, not only does the amount of generated sparks become small, variation in the spark amount can also be reduced. Therefore, the abnormal wear of the commutator 70 and the brush 50 due to the electric discharge can be reduced, and variation in the amount of abnormal wear can also be limited.

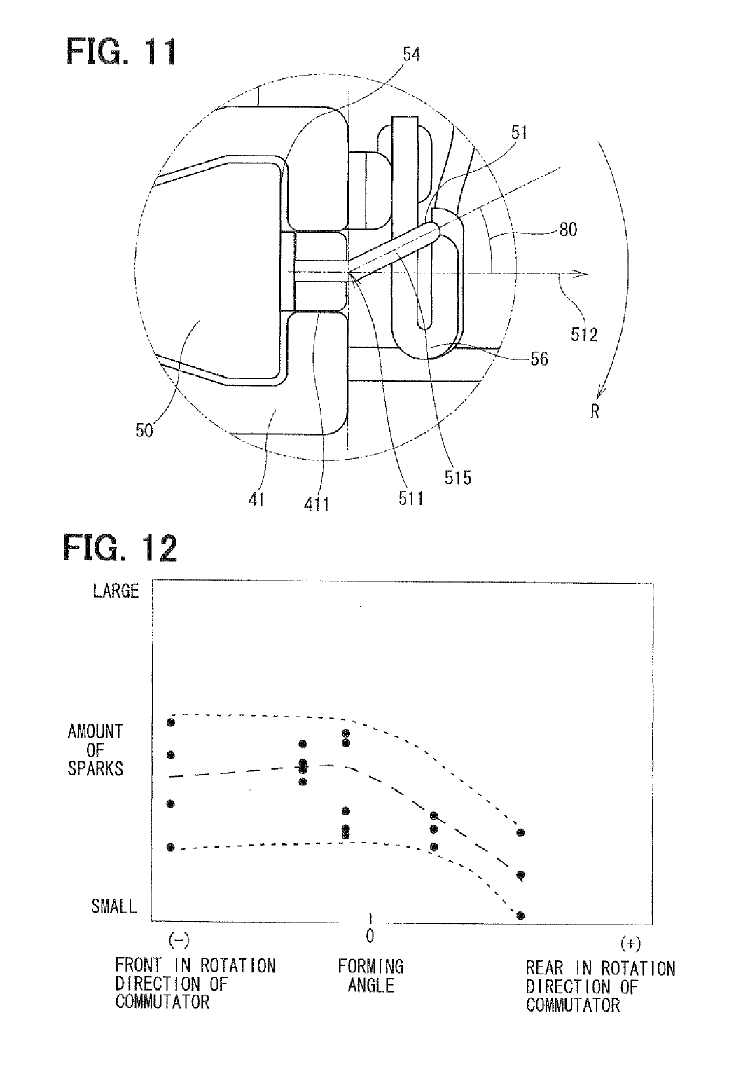

In order to investigate a relationship between an extending direction of the pigtail 50 and the amount of sparks generated, an angle made by the extending pigtail 50 is defined as in FIG. 11. A point, at which an outer wall surface of the motor casing 41 in its outer peripheral direction and the pigtail 51 extending out from the opening 411 intersect with each other, is referred to as an origin point 511. A straight line passing through the origin point 511 and extending outwardly in a direction of the normal line of the side surface 54 of the brush 50 is referred to as an X-axis 512. A plane that is horizontal relative to the fuel pump 10 and includes the X-axis 512 is referred to as a horizontal plane 513 (see FIG. 5B). When the extension portion 515 of the pigtail 51 extending out of the side surface 54 of the brush 50 passes through the origin point 511, to extend toward the rear or front in the rotation direction of the commutator 70, the extension portion 515, the extension portion 515 is projected on the horizontal plane 513. In such a case, an angle between a shadow of the projected extension portion 515 and the X-axis 512 is referred to as a forming angle 80. When viewed from the X-axis 512, if the forming angle 80 is made on the rear side in the rotation direction of the commutator 70, the forming angle 80 takes a positive value; and if the forming angle 80 is made on the front side in the rotation direction of the commutator 70, the forming angle 80 takes a negative value.

As illustrated in FIG. 12, by the forming angle 80 taking a positive value, the amount of sparks becomes small, and variation in the amount of sparks also becomes small.

In addition, in the present embodiment, the extension portion 515 of the pigtail 51 connected to the side surface 54 of the brush 50 is pulled out in the opposite direction from the rotation center of the commutator 70. Then, the extension portion 515 extends toward the rear in the rotation direction of the commutator 70. Accordingly, an interference of the pigtail 51 with its peripheral components can be prevented with the above-described tension F2 by the pigtail 51 maintained.

### Second Embodiment

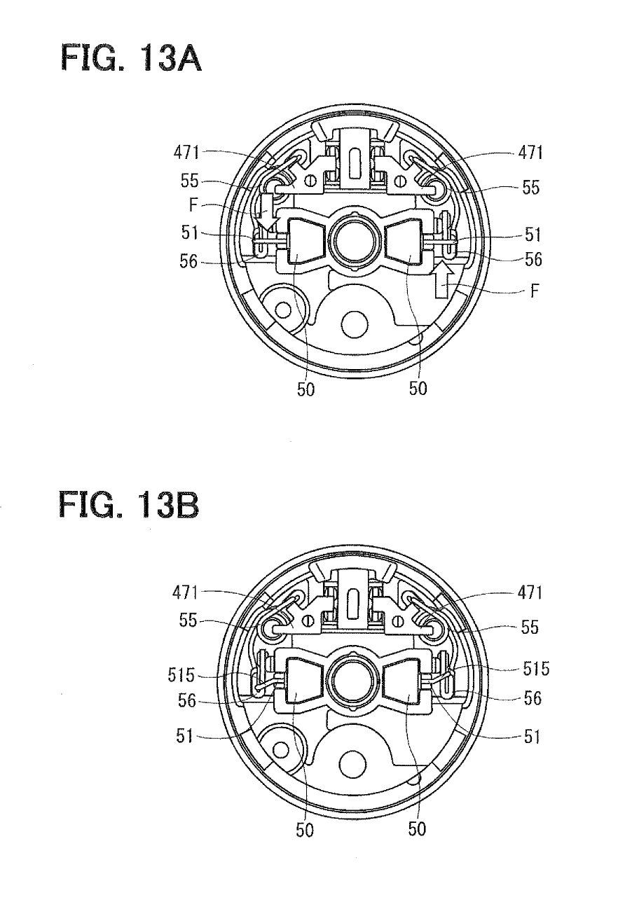

A second embodiment of the invention will be described with reference to FIGS. 13A and 13B. The second embodiment is different from the first embodiment in the method for forming the extension portion of the pigtail. The same numerals are used for indicating substantially the same components as the first embodiment, and their descriptions are omitted.

A method for making an extension portion 515 of a pigtail 51 in a fuel pump 10 of the second embodiment includes mainly the following processes. A brush terminal 56 and a brush 50 are attached to a fuel discharge cover 42 and a motor casing 41. Then, one end portion of the pigtail 51 is connected to the attached brush 50. Moreover, the other end portion of the pigtail 51 is connected to the attached brush terminal 56.

Next, force F is applied to the pigtail 51, which is connected to the brush 50 and the brush terminal 56. To the pigtail 51 on the right-hand side in FIG. 13A, the force F is applied upward on a plane of paper of FIGS. 13A and 13B. As well, to the pigtail 51 on the left-hand side in FIG. 13A, the force F is given downward on the plane of paper of FIGS. 13A and 13B. Accordingly, the pigtail 51 has the extension portion 515 as illustrated in FIG. 13B.

By the production method for the fuel pump 10 of the second embodiment, the extension portion 515 of the pigtail 51 can be formed even after the attachment of the components to the fuel discharge cover 42 and the motor casing 41.

Modifications of the above embodiments will be described. In the above-described embodiments, the pigtail 51 extends to the rear in the rotation direction of the commutator 70, and then, the pigtail 51 changes its direction to the front in the rotation direction of the commutator 70 at the generally intermediate portion of the pigtail 51 so as to be connected to the brush terminal 56. Alternatively, the point, at which to change the shape and extending direction of the pigtail 51 after its generally intermediate portion, is not necessarily limited to this. As a result of this, the fuel pump 10 has an advantage owing to a high degree of flexibility in design of a positional relationship between the brush 50 and the brush terminal 56.

In the above-described embodiments, the pigtail 51 has the urging force by resilience due to its resilient deformation, which is applied to the brush 50. Alternatively, a deformed state of the pigtail 51 is not necessarily limited to the resilient deformation. For example, even if the pigtail 51 is plastically deformed, the pigtail 51 may be employed as long as the pigtail 51 can apply the urging force toward the rear side in the rotation direction of the commutator 70 by its restoring force to the brush 50.

As above, the invention is not by any means limited to the above embodiments, and may be embodied in various modes without departing from the scope of the invention.

To sum up, the fuel pump 10 and the method for making the fuel pump 10 in accordance with the above embodiments may be described as follows.

The fuel pump 10 includes a pump part 12, a motor part 14, two brushes 50, two pigtails 51, and an urging member 60. The pump part 12 includes an impeller 33 and is configured to suction and pressurize fuel. The motor part 14 includes a rotor 20, a commutator 70, and a motor casing 41. The rotor 20 is coupled with a rotating shaft 21 of the impeller 33 to be capable of rotating the impeller 33. The commutator 70 is rotated together with the rotor 20 to rectify an electric current supplied to the rotor 20. The motor casing 41 accommodates the rotor 20 and the commutator 70. Each of the two brushes 50 includes a side surface 54 and one axial end face 52 that slides on the commutator 70 to be electrically connectable to the commutator 70, and the two brushes 50 are accommodated in the motor casing 41 movably in an axial direction thereof. Each of the two pigtails 51 is made of a linear conductive member and includes one end portion that is electrically and mechanically connected to a corresponding one of the two brushes 50. The urging member 60 includes one end which is engaged with the motor casing 41, and the other end which is configured to press and urge each of the two brushes 50 against the commutator 70 from the other axial end face 53 of the each of the two brushes 50. The other axial end face 53 of each of the two brushes 50, with which the other end of the urging member 60 is in contact, includes an inclined surface 53. A distance between the inclined surface 53 and a sliding surface 71 of the commutator 70, on which the one axial end face 52 of each of the two brushes 50 slides, in an axial direction of the each of the two brushes 50 becomes longer toward a rear side of the each of the two brushes 50 in a rotation direction of the commutator 70. The motor casing 41 includes two brush accommodating chambers 45, each of which accommodates a corresponding one of the two brushes 50. The side surface 54 and an inner wall 412 of the motor casing 41, which defines each of the two brush accommodating chambers 45, define a clearance 451 therebetween. Each of the two pigtails 51 includes an extension portion 515 extending from the one end portion thereof toward the rear side in the rotation direction of the commutator 70.

Accordingly, when urging force toward the commutator 70 is applied by the urging member 60 to the brush 50, the end face of the brush 50 that is in contact with the urging member 60 is inclined backward in the rotation direction of the commutator 70. Therefore, on the contact surface between the commutator 70 and the brush 50, the pressing force of the brush 50 against the commutator 70 becomes larger further backward in the rotation direction of the commutator 70. Furthermore, the pigtail 51 applies the force, which pulls the brush 50 backward in the rotation direction of the commutator 70, to the brush 50, which is connected to the pigtail 51. As a result of the above-described configuration of the fuel pump 10, the brush 50 that slides on the commutator 70 is pushed on the commutator 70 by the force that becomes larger further backward in the rotation direction of the commutator 70, maintaining a state in which the end face of the brush 50 that is in contact with the urging member 60 is inclined backward in the rotation direction of the commutator 70.

Fuel flowing through the pumping device 10 exists at the sliding surfaces 52, 71 between the brush 50 and the commutator 70. In this case, as the pressing force of the brush 50 against the commutator 70 is larger, the fuel existing at the sliding surfaces 52, 71 between the commutator 70 and the brush 50 can be further removed, and contact resistance between the commutator 70 and the brush 50 can be made smaller. Therefore, the contact resistance between the commutator 70 and the brush 50 becomes smaller further on the rear side in the rotation direction of the commutator 70. Accordingly, at the sliding surfaces 52, 71 between the brush 50 and the commutator 70, an electric current easily flows on the rear side in the rotation direction of the commutator 70. On the other hand, because the contact resistance is great on the front side in the rotation direction of the commutator 70, an electric current does not easily flow. As a result, electric discharge is not easily produced on the front side in the rotation direction of the commutator 70, on which the contact between the rotating commutator 70 and the brush 50 is released. Thus, the development of abnormal wear of the commutator 70 and the brush 50 caused by the electric discharge can be limited.

The extension portion 515 may extend from the one end portion of each of the two pigtails 51 in an opposite direction from a rotation center of the commutator 70.

In this case, the pigtail 51 has a shape that is pulled out from the brush 50 in the opposite direction from the rotation center of the commutator 70 and that extends backward in the rotation direction of the commutator 70. Accordingly, with the pigtail 51 maintaining the force that pulls the brush 50 backward in the rotation direction of the commutator 70, an interference between peripheral components of the brush 50, such as the motor casing 41, and the pigtail 51, can be eliminated.

The extension portion 515 may extend from the one end portion of each of the two pigtails 51 in an opposite direction from a rotation center of the commutator 70 as well as toward the rear side in the rotation direction of the commutator 70.

Similar to the above, the interference with peripheral components of the brush 50 can be eliminated with the urging force, which is applied to the brush 50 by the pigtail 51, maintained.

Each of the two pigtails 51 may be resiliently deformable.

Accordingly, the pigtail 51, which is formed on the rear side in the rotation direction of the commutator 70, can pull the brush 50 with even larger force backward in the rotation direction of the commutator 70 using its resilient force.

The fuel pump 10 may further include two brush terminals 56, each of which is configured to supply electric power to a corresponding one of the two pigtails 51. Each of the two pigtails 51 may include the other end portion that is connected to a corresponding one of the two brush terminals 56. The motor casing 41 and the two brush terminals 56 may be integrally formed. The one end portion of each of the two pigtails 51 may be connected to a corresponding one of the side surfaces 54 of the two brushes 50.

Accordingly, the brush 50 and the brush terminal 56, which are connected by the pigtail 51, are located close to each other, and as a result, the pigtail 51 becomes short. In the case of the short pigtail 51, the urging force due to the bending of the pigtail 51 is made large, and therefore, urging force in an unintended direction may be applied to the brush 50. In the fuel pump 10, the pigtail 51 is formed to extend backward in the rotation direction of the commutator 70, so that the urging force in an unintended direction applied to the brush 50 is eliminated, and the development of electric discharge between the brush 50 and the commutator 70 is thereby curbed. Consequently, the development of abnormal wear of the commutator 70 and the brush 50 caused by the electric discharge can be limited.

According to the method for making the fuel pump 10, a first connecting process is performed. In the first connecting process, the one end portion of each of the two pigtails 51 is connected to a corresponding one of the two brushes 50. Furthermore, a second connecting process is performed. In the second connecting process, the other end portion of each of the two pigtails 51 is electrically and mechanically connected to a corresponding one of two brush terminals 56 configured to supply electric power to the each of the two pigtails 51. Then, a flexural formation process is performed after the first and second connecting processes. In the flexural formation process, each of the two brushes 50 and a corresponding one of the two brush terminals 56 are brought close to each other, with each of the two pigtails 51 connected to a corresponding one of the two brushes 50 and to a corresponding one of the two brush terminals 56, so as to shorten a distance between the one end portion and the other end portion of the each of the two pigtails 51 and thereby to provide a flexure for the each of the two pigtails 51. Subsequently, a first extension portion formation process is performed after the flexural formation process. In the first extension portion formation process, the extension portion 515 is provided for each of the two pigtails 51. The extension portion 515 extends toward the rear side in the rotation direction of the commutator 70.

A fuel pump 10 made by this production method produces similar effects to the above-described fuel pump 10.

According to the method for making the fuel pump 10, an attachment process is performed. In performing the attachment process, the two brushes 50 and two brush terminals 56 are attached to the motor casing 41, each of the two brush terminals 56 being configured to supply electric power to a corresponding one of the two pigtails 51. Furthermore, a third connecting process is performed. In performing the third connecting process, the one end portion of each of the two pigtails 51 is connected to a corresponding one of the two brushes 50. In addition, a fourth connecting process is performed. In performing the fourth connecting process, the other end portion of each of the two pigtails 51 is connected to a corresponding one of the two brush terminals 56. Then, a second extension portion formation process is performed after the attachment process and the third and fourth connecting processes. In performing the second extension portion formation process, the extension portion 515 is provided for each of the two pigtails 51 with the two brushes 50 and the two brush terminals 56 attached to the motor casing 41. The extension portion (515) extends toward the rear side in the rotation direction of the commutator 70.

A fuel pump 10 made by this production method produces similar effects to the above-described fuel pump 10.

Additional advantages and modifications will readily occur to those skilled in the art. The invention in its broader terms is therefore not limited to the specific details, representative apparatus, and illustrative examples shown and described.

What is claimed is:

1. A fuel pump comprising:
a pump part that includes an impeller and is configured to suction and pressurize fuel;
a motor part that includes:
a rotor coupled with a rotating shaft of the impeller to be capable of rotating the impeller;
a commutator rotated together with the rotor to rectify an electric current supplied to the rotor; and
a motor casing accommodating the rotor and the commutator;
two brushes, each of which includes a side surface and one axial end face that slides on the commutator to be electrically connectable to the commutator, and which are accommodated in the motor casing movably in an axial direction thereof;
two pigtails, each of which is made of a linear conductive member and includes one end portion that is electrically and mechanically connected to a corresponding one of the two brushes; and
an urging member that includes one end which is engaged with the motor casing, and the other end which is configured to press and urge each of the two brushes against the commutator from the other axial end face of the each of the two brushes, wherein:
the other axial end face of each of the two brushes, with which the other end of the urging member is in contact, includes an inclined surface;
a distance between the inclined surface and a sliding surface of the commutator, on which the one axial end face of each of the two brushes slides, in an axial direction of the each of the two brushes becomes longer toward a rear side of the each of the two brushes in a rotation direction of the commutator;
the motor casing includes two brush accommodating chambers, each of which accommodates a corresponding one of the two brushes;
the side surface and an inner wall of the motor casing, which defines each of the two brush accommodating chambers, define a clearance therebetween; and
each of the two pigtails includes an extension portion extending from the one end portion thereof toward the rear side in the rotation direction of the commutator.

2. The fuel pump according to claim 1, wherein the extension portion extends from the one end portion of each of the two pigtails in an opposite direction from a rotation center of the commutator.

3. The fuel pump according to claim 1, wherein the extension portion extends from the one end portion of each of the two pigtails in an opposite direction from a rotation center of the commutator as well as toward the rear side in the rotation direction of the commutator.

4. The fuel pump according to claim 1, wherein each of the two pigtails is resiliently deformable.

5. The fuel pump according to claim 1, further comprising two brush terminals, each of which is configured to supply electric power to a corresponding one of the two pigtails, wherein:
each of the two pigtails includes the other end portion that is connected to a corresponding one of the two brush terminals; and
the motor casing and the two brush terminals are integrally formed.

6. The fuel pump according to claim 1, wherein the one end portion of each of the two pigtails is connected to a corresponding one of the side surfaces of the two brushes.

7. A method for making the fuel pump recited in claim 1, comprising:
performing a first connecting process, wherein the performing of the first connecting process includes connecting the one end portion of each of the two pigtails to a corresponding one of the two brushes;
performing a second connecting process, wherein the performing of the second connecting process includes electrically and mechanically connecting the other end portion of each of the two pigtails to a corresponding one of two brush terminals configured to supply electric power to the each of the two pigtails;
performing a flexural formation process after the first and second connecting processes, wherein the performing of the flexural formation process includes bringing each of the two brushes and a corresponding one of the two brush terminals dose to each other, with each of the two pigtails connected to a corresponding one of the two brushes and to a corresponding one of the two brush terminals, so as to shorten a distance between the one end portion and the other end portion of the each of the two pigtails and thereby to provide a flexure for the each of the two pigtails; and
performing a first extension portion formation process after the flexural formation process, wherein:
the performing of the first extension portion formation process includes providing the extension portion for each of the two pigtails; and
the extension portion extends toward the rear side in the rotation direction of the commutator.

8. A method for making the fuel pump recited in claim 1, comprising:
performing an attachment process, wherein the performing of the attachment process includes attaching the two brushes and two brush terminals to the motor casing, each of the two brush terminals being configured to supply electric power to a corresponding one of the two pigtails;
performing a third connecting process, wherein the performing of the third connecting process includes connecting the one end portion of each of the two pigtails to a corresponding one of the two brushes;
performing a fourth connecting process, wherein the performing of the fourth connecting process includes connecting the other end portion of each of the two pigtails to a corresponding one of the two brush terminals; and
performing a second extension portion formation process after the attachment process and the third and fourth connecting processes, wherein:
the performing of the second extension portion formation process includes providing the extension portion for each of the two pigtails with the two brushes and the two brush terminals attached to the motor casing; and
the extension portion extends toward the rear side in the rotation direction of the commutator.
